(19) United States
(12) Patent Application Publication
(10) Pub. No.: US 2005/0033938 A1
(43) Pub. Date: Feb. 10, 2005

(54) Network processing system, core language processor and method of executing a sequence of instructions in a stored program

(75) Inventors: Gordon Taylor Davis, Chapel Hill, NC (US); Marco C. Heddes, Raleigh, NC (US); Ross Boyd Leavens, Cary, NC (US); Mark Anthony Rinaldi, Durham, NC (US)

Correspondence Address: DRIGGS, LUCAS BRUBAKER & HOGG CO. L.P.A., DEPT. IRA, 8522 EAST AVENUE, MENTOR, OH, 44060, US

(73) Assignee: International Business Machines Corporation, Armonk, NY (US)

(21) Appl. No.: 10/940,434

(22) Filed: Sep. 14, 2004

Related U.S. Application Data
(63) Continuation of application No. 09/548,109, filed on Apr. 12, 2000.

(51) Int. Cl. G06F 15/00

(52) U.S. Cl. 712/34

(57) ABSTRACT

A network processor utilizes protocol processor units (PPUs) to provide instruction communication for the network. Each PPU includes a core language processor (CLP). Each CLP contains general purpose registers and includes a coprocessor that contains scalar registers and array registers. The CLP controls and instructs a plurality of coprocessors that run in parallel with the CLP. Each coprocessor is a specialized hardware assist engine having direct access to the CLP registers and arrays through two sets of interface signals, a coprocessor execution interface and a coprocessor data interface.

### CROSS-REFERENCE TO RELATED APPLICATION

This application is a continuation of application Ser. No. 09/548,109, filed Apr. 12, 2000.

### FIELD OF THE INVENTION

The invention relates to the field of network processors. More particularly, it relates to the use of protocol processing units for the network processors that are interfaced with special function coprocessors to provide high capacity message handling with real time response.

### BACKGROUND OF THE INVENTION

The use of a protocol processor unit (PPU) to provide for and to control the programmability of a network processor is well known. Likewise, the use of coprocessors with the PPU in the design of a computer system processing complex architecture is well established. Delays in processing events that require real time processing is a problem that directly affects system performance. By assigning a task to a specific coprocessor, rather than requiring the protocol processor unit to perform the task, a designer may increase the efficiency and performance of a computer system. Adding a coprocessor to a system under the prior art requires the redesign of the hardware that provides the instructions required by the PPU to operate the coprocessor. However, a significant drawback to the efficient use of coprocessors is the need to redesign this hardware whenever a coprocessor is changed or added to the system.

### SUMMARY OF THE INVENTION

The deficiencies of the prior art network processors are overcome in accordance with the present invention as hereafter described.

The present invention consists of a novel processing system and its method of use. The system comprises the following structural components:

a main processing unit, at least one, and preferably several, coprocessor units and an interface between the main processing unit and each of the coprocessor units. The main processing unit executes a sequence of instructions in a stored program. Each coprocessor unit is responsive to said main processing unit and is adapted to efficiently perform specific tasks under the control of the main processing unit. The interface between the main processing unit and each coprocessor unit enables one or more of the following functions: configuration of each coprocessor unit; initiation of specific tasks to be completed by each coprocessor unit; access to status information relating to each coprocessor unit; and providing means for returning results relating to specific tasks completed by each coprocessor unit. The main processing unit and coprocessor unit(s) each includes one or more special purpose registers. The interface is capable of mapping the special purpose registers from said main processing unit and coprocessor units into a common address map.

Typically, the main processing unit is a network processor, and each coprocessor unit is able to execute specific networking tasks. For example, one coprocessor unit computes CRC checksums. Another coprocessor unit moves blocks of data between local memory or array registers and a larger main memory. Another coprocessor unit searches a tree structure for data which corresponds to a specified key. One coprocessor unit assists in the enqueuing of packets once processing is complete. Still another coprocessor unit assists in accessing the contents of registers within said processing system. Preferably, the special purpose registers include scalar registers and array registers.

Another embodiment of the present invention is a method involving the steps of: executing a sequence of instructions in a stored program of a main processing unit, and performing specific tasks in at least one coprocessor unit responsive to the main processing unit and subject to the control of the main processing unit. An interface between the main processing unit and the coprocessor unit enables one or more of the following functions:
configuring of each coprocessor unit;
initiating specific tasks to be completed by each coprocessor unit;
accessing status information relating to each coprocessor unit; and
returning results relating to specific tasks completed by each coprocessor unit.

The main processing unit and the coprocessor units each include one or more special purpose registers including scalar registers and array registers. The method of use includes the step of interface mapping the special purpose registers from the main processing unit and each coprocessor unit into a common address map.

In the processing system, the method preferably utilizes several coprocessors for the following special tasks: One coprocessor searches a tree structure for data which corresponds to a specified key. Another coprocessor unit computes CRC checksums. Yet another coprocessor unit assists in the enqueuing of packets once processing is complete. A separate coprocessor unit assists in accessing the contents of registers within said processing system. One coprocessor unit moves blocks of data between local memory or array registers and a larger main memory.

After initiating a task in a coprocessing unit, the main processing unit may either continue execution of instructions or it may stall the execution of further instructions until the completion of the task in the coprocessing unit. In the case where the main processing unit continues execution of instructions concurrent with task execution within the coprocessors, at some subsequent point in time, the execution of a WAIT instruction by the main processor unit will cause it to stall the execution of further instructions until the completion of task execution on one or more coprocessors. In one form, the WAIT instruction stalls execution on the main processing unit until task completion within one or more coprocessors, at which time the main processing unit resumes instruction execution at the instruction following the WAIT instruction. In another form, the WAIT instruction stalls execution of the main processing unit until task completion within a specific coprocessor. When that task completes, the main processing unit examines a one-bit return code from the coprocessor along with one bit from within the WAIT instruction to determine whether to resume instruction execution at the instruction following the WAIT instruction or branch execution to some other instruction specified by the programmer.

The invention also contemplates the use of an interface between a main processing unit and one or more coprocessor units, capable of executing specific networking tasks. The interface enables one or more of the following functions:
configuration of each coprocessor unit;
initiation of specific tasks to be completed by each coprocessor unit;
obtaining access to status information relating to each coprocessor unit; and
providing means for returning results relating to specific tasks completed by each coprocessor unit.

The main processing unit and the coprocessor unit each contain one or more special purpose scalar and array registers. These special purpose registers are mapped from the main processing unit and coprocessor units into a common address map.

### BRIEF DESCRIPTION OF THE DRAWINGS

FIG. 1 shows the block diagram of a protocol processing unit (PPU).

FIG. 2 shows the structure of a coprocessor's scalar registers.

FIG. 3a shows the structure of a coprocessor's array registers.

FIG. 3b illustrates addressing into an array register.

FIG. 4 shows the complete instruction set for the core language processor (CLP).

FIG. 5a shows the structure of the general purpose registers (GPRS) of the CLP.

FIG. 5b shows the layout of the CLP's scalar registers.

FIG. 5c shows the layout of the CLP's array registers.

FIG. 6 describes the coprocessor execution interface (CPEI) and the coprocessor data interface (CPDI) which connects the CLP to its coprocessors.

FIGS. 7a, 7b and 7c illustrate the load/store instruction formats.

FIGS. 8a and 8b illustrate the coprocessor execute instruction formats.

FIGS. 9a and 9b illustrate the wait instruction formats.

### DETAILED DESCRIPTION OF THE INVENTION

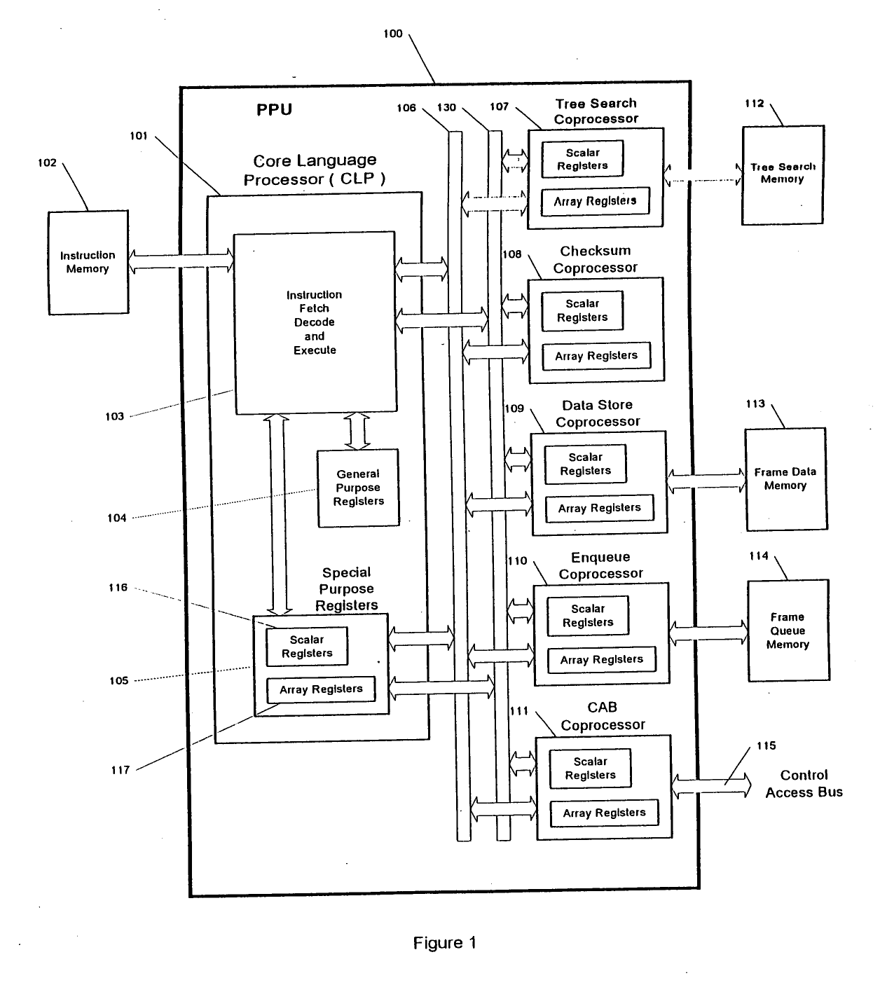

The invention will be described in terms of a protocol processor unit (PPU) that provides and controls the programmability of a network processor. Referring to FIG. 1, the PPU (100) comprises a core language processor (CLP) (101) and five attached coprocessors (107, 108, 109, 110, 111). These coprocessors provide hardware acceleration for specific network processing tasks such as high speed pattern search, data manipulation, internal chip management functions, frame parsing, and data fetching.

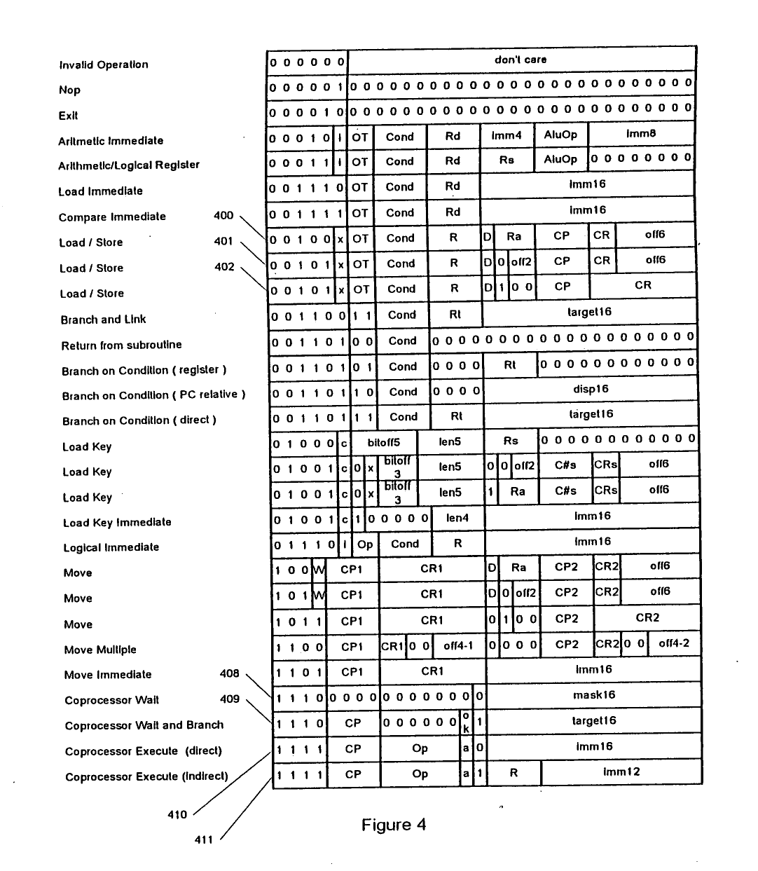

Referring to FIG. 1, the CLP (101) comprises an instruction fetch, decode, and execute unit (103) and a set of general purpose registers (104). The table in FIG. 4 shows the CLP instruction formats which represent a set typical of a general purpose computer. They support:
Binary arithmetic operations add and subtract
Bit-wise Logical AND, OR, and NOT
Compare
Count leading zeros
Shift left/right logical
Shift right arithmetic
Rotate left and right
Bit manipulation commands; Set, clear, test, and flip;
Loading a general purpose register with immediate data
Branching

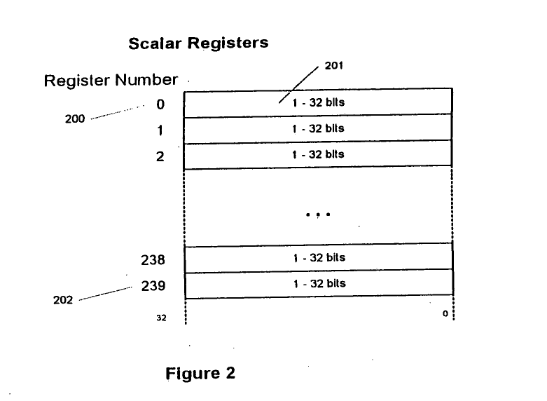

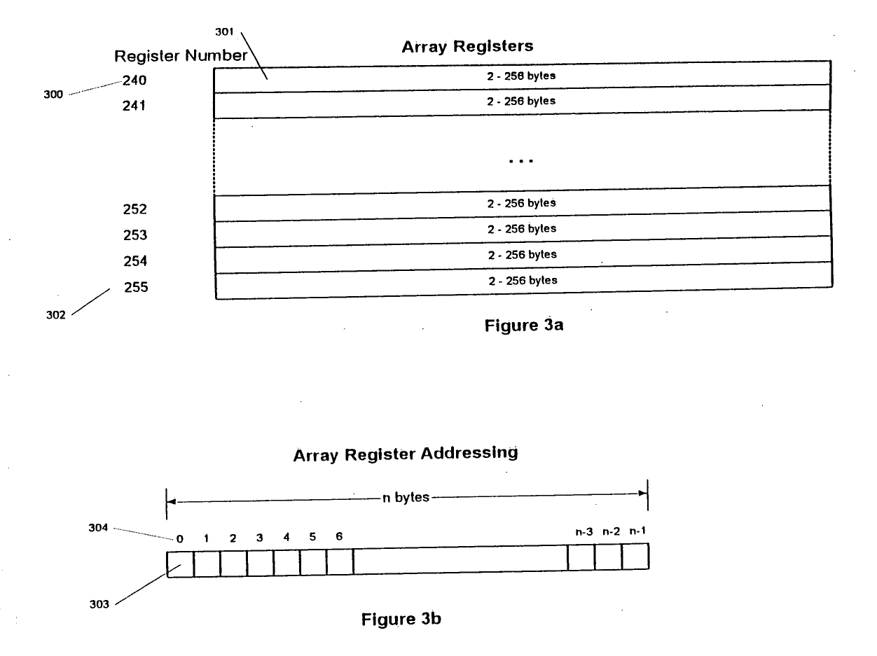

Each instruction is 32 bits long. Instructions (400, 401, 402, 408, 409, 410, and 411) of FIG. 4 relate to operations involving the coprocessors and are central to the invention. Again referring to FIG. 1, the CLP fetches an instruction from instruction memory (102), and decodes it within its instruction decode unit (103). With the exception of two instructions, the CLP (101) completely executes the instruction within its execution unit (103). The two exceptions are the coprocessor execute (direct) instruction (409) of FIG. 4 and the coprocessor execute (indirect) instruction (410) of FIG. 4. These two instructions initiate command processing on one of the attached coprocessors. The coprocessors can execute commands concurrently with each other and concurrently with instruction processing within the CLP. Coprocessors provide two types of special purpose registers: scalar registers and array registers which are described in more detail in FIGS. 2 and 3. Whenever a CLP instruction involves a coprocessor, it specifies a four-bit number called coprocessor identifier in the range 0 to 15 indicating which coprocessor is to be selected for the operation.

The current configuration of the invention contains five coprocessors. Referring to FIG. 1, the following is a brief summary of each of these coprocessors:

1. A tree search engine (TSE) coprocessor (107) is assigned coprocessor identifier 2. The TSE has commands for tree management and direct access to a tree search memory (112). It has search algorithms for performing searches for LPM (longest prefix match patterns requiring variable length matches), FM (fixed size patterns having a precise match) and SMT (software managed trees involving patterns defining either a range or a bit mask set) to obtain frame forwarding and alteration information. Details of a tree search architecture and operation useful in the present invention can be found in the following U.S. patent applications: Ser. Nos. 09/543,531; 09/544,992 and 09/545,100 (Docket Numbers: RAL 9-99-0139; RAL 9-99-0140 and RAL 9-99-0141).

2. A data store coprocessor (109), assigned coprocessor identifier 1, for collecting, altering or introducing frame data into the network processor's frame data memory (113). Details are shown in U.S. patent application Ser. No. 09/384,691 (Docket Number RAL 9-99-0083).

3. The CAB coprocessor (111), assigned coprocessor identifier 3, provides the CLP with access to the control access bus interface (CAB) (115). This bus provides access to the network processor's internal configuration and control registers. The architecture and operation of the CAB are shown in U.S. patent application Ser. No. 09/384,691 (Docket Number RAL 9-99-0083).

4. A conventional checksum coprocessor, assigned coprocessor identifier 5, to calculate and validate header checksums. Details are shown in U.S. patent application Ser. No. 09/384,691 (Docket Number RAL 9-99-0083).

5. An enqueue coprocessor (110), assigned coprocessor identifier 4, to enqueue frames to the network processor's various frame queues. Details are shown in U.S. patent application Ser. No. 09/384,691 (Docket Number RAL 9-99-0083).

The CLP (101) itself contains special purpose register unit (105) with scalar registers (116) and array registers (117) mapped within the address space assigned to coprocessor identifier 0. The CLP (101) does not execute any commands.

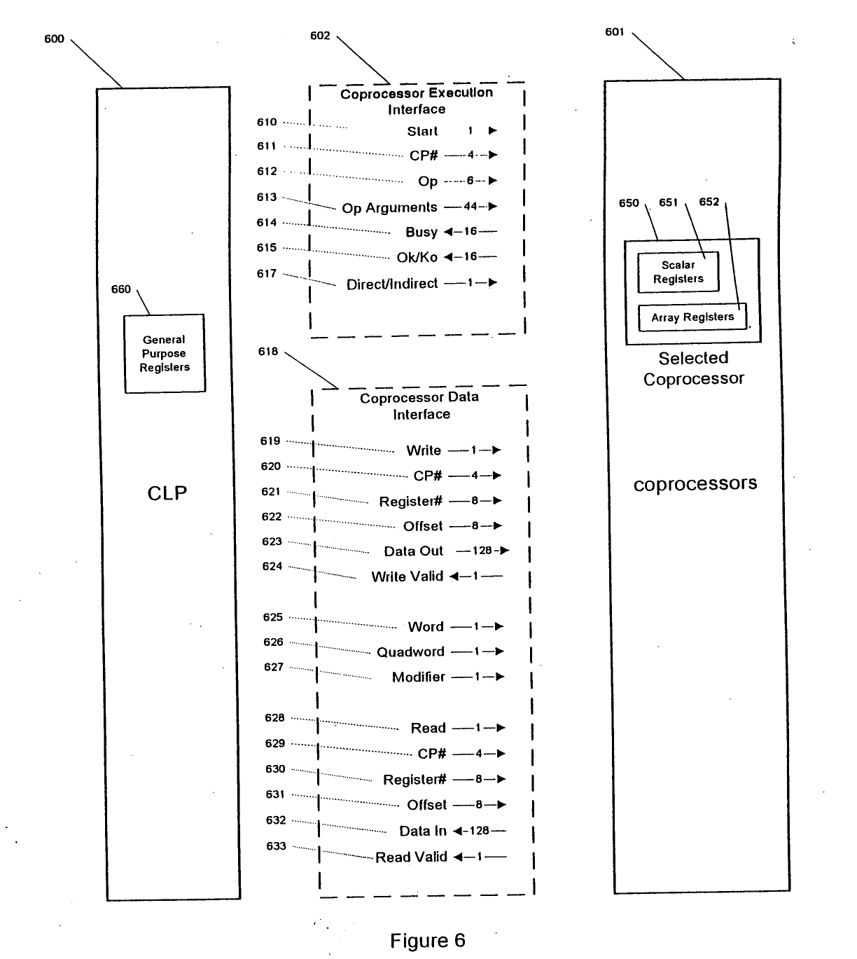

Referring again to FIG. 1, the CLP (101) is connected to its coprocessors (107, 108, 109, 110 and 111) via two interfaces: the coprocessor execution interface (106) and the coprocessor data interface (130). These interfaces are described in more detail in FIG. 6.

As mentioned earlier, the four-bit coprocessor identifier uniquely identifies each coprocessor within the PPU (100) of FIG. 1. Each coprocessor can support up to 256 special purpose registers. An eight-bit register number in the range 0 to 255 uniquely identifies a special purpose register within a coprocessor. The combination of coprocessor number and register number uniquely identifies the register within the PPU. There are two types of special purpose registers: scalar registers and array registers.

Referring to FIG. 2, the register numbers 0 (200) through 239 (202) are reserved for scalar registers. A scalar register (201) has a minimum length of one bit and a maximum length of 32 bits. Scalar register bits are numbered 0 through 31 starting with 0 at the rightmost or least significant bit and ending with 31 or the leftmost or most significant bit. Scalar registers of lengths less than 32 bits are right aligned and the remaining bits are considered unimplemented. When the CLP reads scalar registers of lengths less than 32 bits, the value of unimplemented bits is hardware dependent. Writing to unimplemented bits has no effect.

Referring to FIG. 3a, the register numbers 240 through 255 are reserved for array registers. An array register has a minimum length of two bytes and a maximum length of 256 bytes. The CLP reads or writes an array register two bytes at a time (halfword), four bytes at a time (word) or 16 bytes at a time (quadword). Referring to FIG. 3b, the CLP can read or write an array register beginning at any byte offset (304) including an odd byte offset. Addressing within an array register is modulo the length of the register. For instance, a quadword access to an n-byte long register beginning at offset n−1 affects the bytes at offsets n−1, 0, 1, and 2.

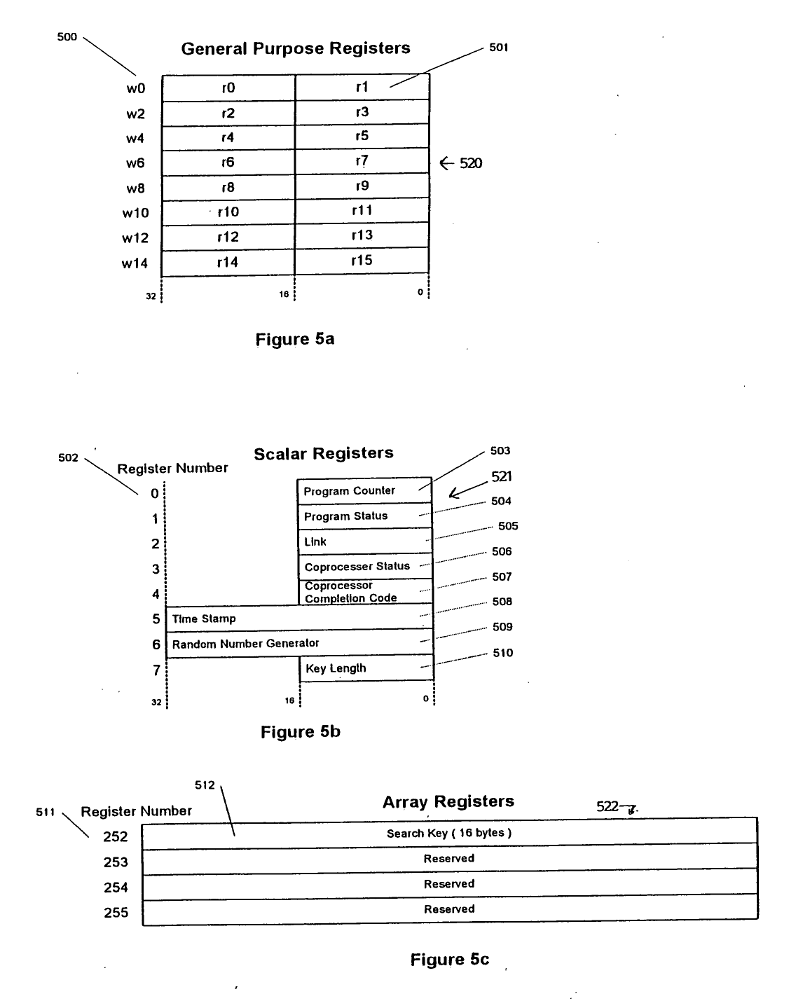

FIG. 5 shows the layout of the general purpose registers (520), the scalar registers (521) and the array registers (522) within the CLP.

Referring to FIG. 5a, the use of general-purpose registers is well-known in the art and, accordingly, will be discussed in a general fashion. The general-purpose registers may be viewed by a programmer in two ways. A programmer may see a general purpose register as a 32-bit register, as is indicated by the 32-bit labels w0 through w14 (500) which are represented with a four-bit number from the set 0, 2, 4, . . . 14. In this sense, the programmer sees eight 32-bit general purpose registers. A programmer may also manipulate a general-purpose register as a 16-bit register, according to the 16-bit labels 501 r0 through r15 which are represented as a four-bit number from the set 0, 1, 2, . . . 15. In this sense, the programmer sees sixteen 16-bit registers.

Referring now to FIG. 5b, the layout of the scalar registers (521) visible to a CLP programmer (103) is depicted. What are important within the scope of the present invention are the coprocessor status register (506) and the coprocessor completion code register (507). The coprocessor status register (506) stores the information from the busy signal field (614) of FIG. 6. This register indicates to a programmer whether a given coprocessor is available, or if it is busy. The coprocessor completion code register (507) stores information from the OK/K.O. field (615) of FIG. 6. Therefore, if a programmer needs to know whether a given coprocessor is busy or is available, the programmer can get this information from the coprocessor status register (506). Similarly, the coprocessor completion code register (506) provides information to a programmer as to the completion of the coprocessor tasks.

The scalar register (521) provides for the following 16-bit program registers: a program counter register (503), a program status register (504), a link register (505), and a key length register (510). Two 32-bit registers are also provided: the time stamp register (508), and the random number generator register (509). A scalar register number (502) is also provided.

The general-purpose registers (520) may be viewed by a programmer in two ways. A programmer may see a general purpose register as a 32-bit register, as is indicated by the 32-bit labels (500) shown in FIG. 5a (w0 through w14). A programmer may also manipulate a general-purpose register as a 16-bit register, according to the 16-bit labels (501) (r0 through r15).

The array registers (522) are revealed to a programmer through the array register numbers (511). FIG. 5c depicts the layout of the array registers within the CLP.

FIG. 6 depicts interface signals which connect the CLP (600) to its coprocessors (601). The coprocessor control interface (106) of FIG. 1 and the coprocessor data interface (130) of FIG. 1 are depicted in FIG. 6 as (602) and (618), respectively. The number of individual wire connections is indicated by the numbering label appearing next to the arrow in each of the individual assignments. For the purposes of this discussion, the selected coprocessor (650) represents the coprocessor whose coprocessor identifier matches the coprocessor identifier appearing on either (611), (620), or (629) depending on the operation as described subsequently.

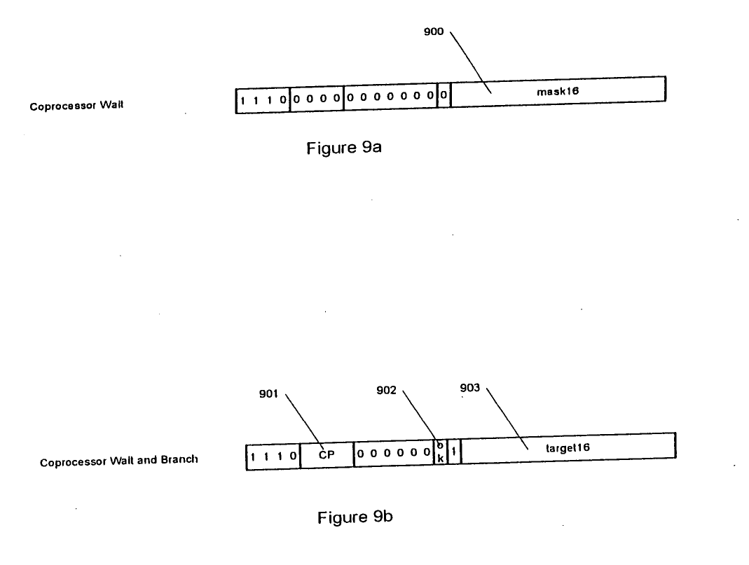

The execution interface (602) enables the CLP (600) to initiate command execution on any of the coprocessors (601). The coprocessor number (611) selects one of 16 coprocessors as the target for the command. When the CLP activates the start field (610) to logical 1, the selected coprocessor (650) as indicated by coprocessor number (611) begins executing the command specified by the 6-bit Op field (612). The op arguments (613) are 44 bits of data that are passed along with the command for the coprocessor (650) to process. The busy signal (614) is a 16-bit field, one bit for each coprocessor (601), and indicates whether a coprocessor is busy executing a command (bit=1) or whether that coprocessor is not executing a command (bit=0). These 16 bits are stored in scalar register (506) of FIG. 5b where bit 0 of the register corresponds to coprocessor 0, bit 1 to coprocessor 1, etc. The OK/K.O. field (615) is a 16-bit field, one bit for each coprocessor (601). It is a one-bit return value code which is command specific. For example, it may be used to indicate to the CLP (600) whether a command given to a coprocessor (601) ended with a failure, or whether a command was successful. This information is stored within the CLP scalar register (507) in FIG. 5b where bit 0 of the register corresponds to coprocessor 0, bit 1 to coprocessor 1, etc. The direct/indirect field (617) indicates to the selected coprocessor (650) which format of the coprocessor execute instruction is executing. If direct/indirect=0, then direct format shown in FIG. 9b is executing; else if direct/indirect=1, then the indirect format shown in FIG. 9a is executing.

The coprocessor data interface (618) comprises three groups of signals. The write interface (619, 620, 621, 622, 623, 624) is involved in writing data to a scalar or array register within a coprocessor. The read interface (627, 628, 629, 630, 631, 632, 633) is involved in reading data from a scalar or array register within a coprocessor. The third group (625, 626, 627) is used during both reading and writing of a scalar register or array register. Duplicate functions on both read interface and write interface serve to support simultaneous read and write to move data from one register to another {e.g. interface signal (620) equivalent to signal (129)}.

The write interface uses the write field (619) to select a coprocessor (650) indicated by the coprocessor number (620). The write field (619) is forced to one whenever the CLP (600) wants to write data to the selected coprocessor. The coprocessor register identifier (621) indicates the register that the CLP (600) will write to within the selected coprocessor (650). The coprocessor register identifier (621) is an eight-bit field and, accordingly, 256 registers are supported. A coprocessor register identifier in the range 0 to 239 indicates a write to a scalar register. A coprocessor register identifier in the range 240 to 255 indicates a write to an array register. In the case of an array register write, the offset field (622) indicates the starting point for the data write operation in the array register. This field is eight-bits in size and, therefore, will support 256 addresses within an array. The data out field (623) carries the data that will be written to the coprocessor (650). It is 128 bits in size and, therefore, up to 128 bits of information may be written in one time. The write valid field (624) indicates to the CLP (600) when the coprocessor (650) is finished receiving the data. This allows the CLP (600) to pause and hold the data valid while the coprocessor 650 takes the data.

The read interface is similar in structure to the write interface except that data is read from the coprocessor. The read field (628) corresponds to the write field (619), and is used by the CLP (600) to indicate when a read operation is to be performed on the selected coprocessor (650). The coprocessor number identifier field (629) determines which coprocessor (650) is selected. The register number field (630), offset field (631), and read valid field (633) correspond to (621), (622), and (624) in the write interface. The data-in field (632) carries the data from the coprocessor (650) to the CLP (600). Read or write operations can have one of three lengths; halfword which indicates that 16 bits are to be transferred, word which indicates that 32 bits are to be transferred, and quadword which indicates that 128 bits are to be transferred. The read data 632 and the write data (623) are 128 bits in width. Data transfers of less than 128 bits are right aligned. Signals (625) and (626) indicate the data transfer size. Sixteen-bit transfers are indicated by (625) and (626) both 0, 32-bits transfers are indicated by (625) and (626) being 1 and 0, respectively, and 128-bit transfers are indicated by (625) and (626) being 0 and 1, respectively.

The modifier field (627) is used during either a data read or data write operation. Each coprocessor interprets its meaning in its own fashion as defined by the coprocessor's hardware designer. It provides a way for the programmer to specify an additional bit of information to the hardware during either a read or write operation. The datestore coprocessor can skip the link field in the packet buffer in a linked list of packet buffers.

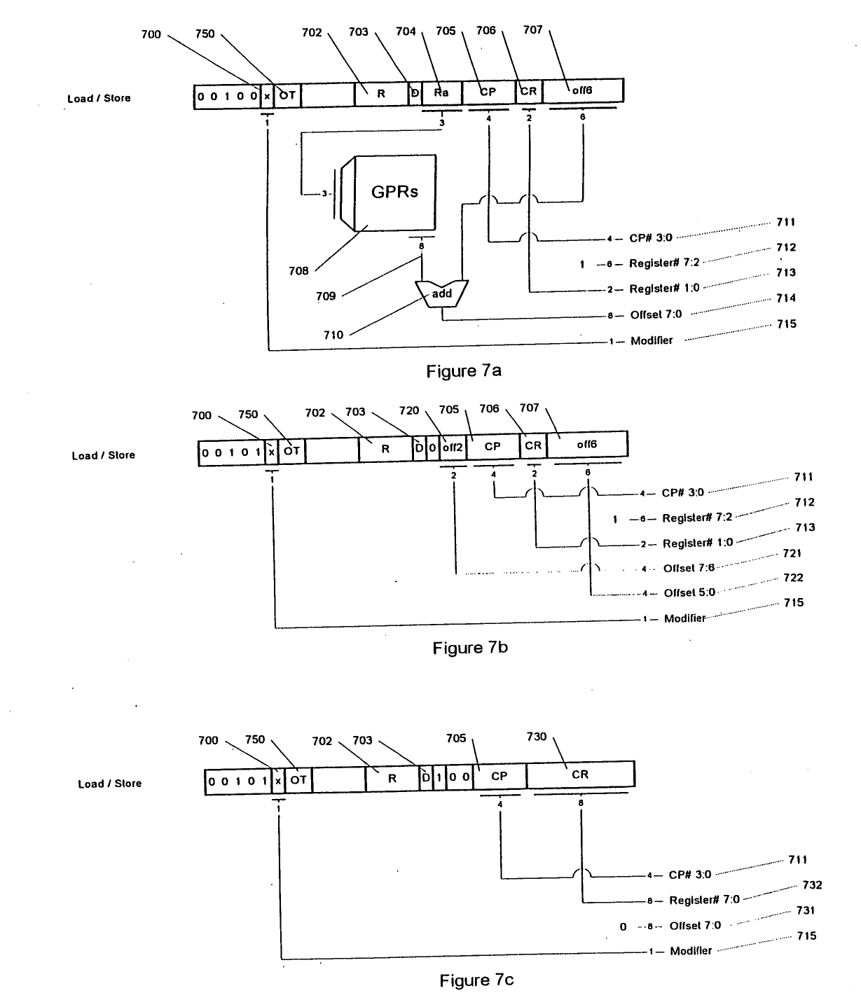

The following sections describe in greater detail the CLP instructions shown in FIG. 4 that pertain to the interaction between the CLP 101 of FIG. 1 and its coprocessors (107, 108, 109, 110, 111, and 105) of FIG. 1. These instructions are broken up into several categories: load/store, coprocessor execute, and wait. FIGS. 7, 8, 9, and 10 show mapping between the bits in the various fields of the instructions and the interface signals shown in (602) and (618) of FIG. 6. In this way, it is demonstrated how the execution of specific CLP instructions (400, 401, 402, 408, 409, 410, and 411) of FIG. 4 results in the activation of specific signals on the interfaces (602) and (618) of FIG. 6.

Referring to FIG. 4, instructions (400, 401, and 402) involve transferring data between the CLP's general purpose registers and a scalar or array register within a coprocessor. These instructions are shown in greater detail in FIG. 7 and are referred to as the load/store instructions. FIG. 7 shows the three different formats for the load/store instruction. FIGS. 7a and 7b are used to transfer data to or from an array register. FIG. 7c shows the format used to transfer data to or from a scalar register. The general purpose register number field (702) specifies which general purpose register within the CLP (660) of FIG. 6 will act as the source or destination of the data transfer. The data direction field D (703) determines the direction of this transfer as described in the following sections:

If field D (703) is equal to 0, then the data is copied from the selected coprocessor (650) of FIG. 6 to the general purpose register (660) of FIG. 6 specified by the general purpose register number field (702). In this case, the signals (625, 626, 627, 628, 629, 630, 631, 632, and 633) of FIG. 6 are used to perform the transfer. The signal (628) of FIG. 6 is set to 1 indicating a read operation. The coprocessor identifier field (705) indicates the selected coprocessor via signal (629) of FIG. 6. The data is transferred via signal (632) of FIG. 6. The 2-bit operand type field (750) determines the width of the data to be copied as follows:

1. If field (750) is equal to 00, then general purpose register number field (702) specifies a 16-bit register as described in (500) of FIG. 5a, signals (625) and (626) of FIG. 6 are set to 0 and 0, respectively, causing 16-bits of data to be transferred from the selected coprocessor (650) of FIG. 6 to the general purpose register (660) of FIG. 6.

2. If field (750) is equal to 01, then general purpose register number field (702) is restricted to contain a number from the set 0, 2, 4, . . . 14 which specifies a 32-bit register as described in register (500) of FIG. 5a. Signals (625) and (626) of FIG. 6 are set to 1 and 0, respectively, causing 32-bits of data to be transferred from the selected coprocessor (650) of FIG. 6 to the general purpose register (660) of FIG. 6.

The following describes the determination of the coprocessor register numbers (621) and (630) in FIG. 6 which indicate which coprocessor register in the selected coprocessor (650) of FIG. 6 participates in the above described data transfers.

FIG. 7a and FIG. 7b show the instruction formats for transferring data to or from an array register (652) of FIG. 6 in the selected coprocessor (650) of FIG. 6. In both instruction formats, the coprocessor register number is determined by assigning the two-bit field (706) to the low order two bits of the coprocessor register number (713). The high order six bits of the coprocessor register number (712) are set to 1. This restricts the coprocessor register number to be in the range 252-255. This is a limitation of the specific embodiment of the invention. Other embodiments could increase the size of the field (706) to four-bits, thereby allowing selection from the full set of array registers 240-255.

For data read operations (direction field (703) equal to 0), the coprocessor register numbers (712) and (713) indicate the selected coprocessor register via signal (630) of FIG. 6. For data write operations, (direction field (703) equal to 1) registers (712) and (713) indicate the selected coprocessor register via signal (621).

Continuing to refer to FIGS. 7a and 7c, the following describes the determination of the eight-bit array offset as described in (303) of FIG. 3b which indicates which bytes from within the selected array register (652) of FIG. 6 are to participate in the data transfer. Referring to FIG. 7a, the offset (707) to the low order eight bits (709) of a 16-bit general purpose register is selected from CPR (708). The selection is performed by using the three-bit number specified by field (704) which selects from the set of 16-bit registers {r0, r1, - - - r7} described in (500) of FIG. 5a. If field (704) equals 0, the r0 is selected; if field (704) equals 1, then r1 is selected, etc.

Referring to FIG. 7b, the full eight-it offsets (721) and (722) are obtained from the instruction. The low order six bits (722) are obtained from (707) and the high order two bits (721) are obtained from (720). For data read operations (direction field 703 equal to 0), the offset (714) or (721) and (722) indicate the selected coprocessor array register offset via signal 631 of FIG. 6. For data write operations (direction field (703) equal to 1), the offsets (714) or (721) and (722) indicate the selected coprocessor array register offset via signal (622) of FIG. 6.

FIG. 7c shows the instruction format for transferring data to or from a scalar register (651) of FIG. 6 in the selected coprocessor (650) of FIG. 6. Here a full eight-bit coprocessor register number (732) is obtained from instruction field (730). For data read operations (direction field (703) equal to 0), the coprocessor register number (730) indicates the selected coprocessor register via signal (630) of FIG. 6. For data write operations (direction field (703) equal to 1), the coprocessor number (730) indicates the selected coprocessor register via signal (621) of FIG. 6.

Instructions (411) and (410) of FIG. 4 imitate command processing on a coprocessor by setting signal (610) of FIG. 6 to a 1.

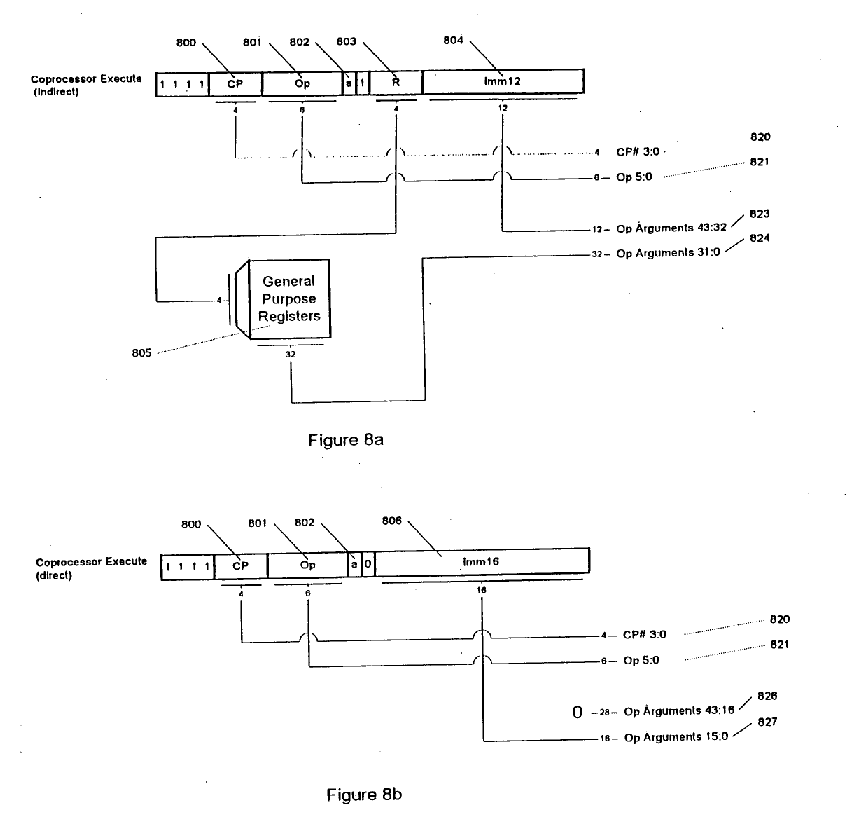

Referring to FIG. 8, the coprocessor identifier (820) is obtained from instruction field (800) and indicates the selected coprocessor (650) of FIG. 6 via the start signal (611) of FIG. 6. The six-bit coprocessor command is obtained from the instruction field (801) and indicates via signal (612) of FIG. 6 to the selected coprocessor (650) of FIG. 6 which command to begin executing. Upon activation of the start signal (610) of FIG. 6 to a 1, the selected coprocessor 650 of FIG. 6 activates to 1 its busy signal (614) of FIG. 6 and keeps it at 1 until it completes execution of the command indicated by signal (612) of FIG. 6, at which time it deactivates this signal to 0. The CLP (600) of FIG. 6 continuously reads the 16 bits of signal (614) and places them into its coprocessor status register (506) of FIG. 5b. Upon completion of the command, the selected coprocessor (650) of FIG. 6 places this status in the appropriate bit of the coprocessor completion code register (507) of FIG. 5b.

Referring once again to FIG. 8, if the asynchronous execution field (802) of the instruction is 0, then the CLP (650) of FIG. 6 indicates command completion by deactivating its busy signal (614). When this occurs, the CLP (600) of FIG. 6 resumes fetching and execution of instructions. If the asynchronous execution field (802) of the instruction is 1, then the CLP (600) of FIG. 6 continues fetching and execution of instructions regardless of the state of the busy signal (614) of FIG. 6.

Upon initiation of command processing in the selected coprocessor (650) of FIG. 6, the CLP (600) of FIG. 6 supplies 44 bits of additional command specific information via signal (613) of FIG. 6. This information is derived in one of two ways depending on the instruction format as depicted in FIGS. 8a and 8b.

The coprocessor execute indirect format of FIG. 8a obtains the high order 12 bits (823) of command information from instruction field (804). The low order 32 bits of command information (824) are obtained from the 32-bit general purpose register selected from the register (805). The selected register is determined by the four-bit instruction field (803) which is restricted to the values {0, 2, 4, . . . 14}. In this way, a 32-bit register from the set {w0, w2, w4, . . . w14} is chosen as shown in register (500) of FIG. 5a. The CLP (600) of FIG. 6 sets signals (617) of FIG. 6 to 1, indicating to the selected coprocessor (650) of FIG. 6 that this is the indirect form of the instruction.

The coprocessor execute direct format of FIG. 8b obtains the low order 16 bits (827) of the command information from instruction field (806). The high order 28 bits (826) of the command information are set to 0. The CLP (600) of FIG. 6 sets signal (617) of FIG. 6 to 0, indicating to the selected coprocessor (650) of FIG. 6 that this is the direct form of the instruction.

Instructions (408) and (409) of FIG. 4 allow the CLP to wait for the completion command execution in one or more coprocessors.

FIG. 9a depicts the instruction format for the coprocessor wait instruction (408) of FIG. 4. The CLP (600) of FIG. 6 performs the bit wise AND operation of the 16-bit mask obtained from instruction field (900) with the coprocessor status register (506) of FIG. 5b. If the result is not zero, indicating that one or more coprocessors are still currently executing commands, the CLP (600) of FIG. 6 stalls fetching and execution of instructions. However, it continues to perform the above AND operation until which time the result is zero.

FIG. 9b depicts the instruction format for the coprocessor wait instruction (408) of FIG. 4. The CLP (600) of FIG. 6 performs the bit wise AND operation of the 16-bit mask obtained from instruction field (900) with the coprocessor status register (506) of FIG. 5b is to be tested. For example if field (901) contains 1, then bit 1 of (506) of FIG. 5b is tested. If (901) contains 15, then bit 15 of coprocessor status (506) in FIG. 5b is tested. If the value of the tested bit is 1, indicating that the corresponding coprocessor has not yet completed command execution, then the CLP (600) of FIG. 6 stalls fetching and execution of instructions. However, it continues to perform the above operation until the value of the tested bit is 0, indicating that the corresponding coprocessor has completed command execution. At this time, one of the two actions occur depending on the value of the ok field (902) of the instruction and the value of the bit in the coprocessor completion code register (507) of FIG. 5b as selected by the coprocessor identifier (901). The CLP (600) of FIG. 6 either resumes fetching and execution at the next sequential instruction or it branches and resumes fetching and execution of instruction at the instruction address indicated by instruction field (903) according to the following table:

| Value | | |
|---|---|---|
| of | Value of Selected Coprocessor | Value of Selected Coprocessor |
| 902 | Completion Code Bit = 0 | Completion Code Bit = 1 |
| 0 | branch | next instruction |
| 1 | next instruction | branch |

The details of the instruction fetch, decode and execute unit within the CLP are known to persons of ordinary skill in the art and do not comprise a part of the present invention, with the exception of the specific instructions that are uniquely oriented to the interfaces and the coprocessors. The specific details relating to the architecture and the programming of the individual coprocessors useful in the present invention are not deemed to comprise a part of the present invention.

While the invention has been described in combination with embodiments thereof, it is evident that many alternatives, modifications, and variations will be apparent to those skilled in the art in light of the foregoing teachings. Accordingly, the invention is intended to embrace all such alternatives, modifications and variations as fall within the spirit and scope of the appended claims.

A portion of the disclosure of this patent document contains material to which a claim for copyright is made. The copyright owner has no objection to the facsimile reproduction by anyone of the patent document or patent disclosure, as it appears in the Patent and Trademark Office patent file or records, but reserves all other copyright rights whatsoever.

1. A core language processor useful for providing and controlling the programmability of a network processor, said core language processor controlling the operation of one or more coprocessors through a plurality of execution instructions including load/store, wait and branch, indirect coprocessor execute and direct coprocessor execute, said instructions being executable within said core language processor.

2. The core language processor according to claim 1 wherein it is connected to each of the coprocessors by two interfaces, an execution interface including instructions that enable the core language processor to initiate command execution on any of the coprocessors, and a data read and write interface.

3. The core language processor according to claim 2 further including the ability to access status information of each coprocessor.

4. The core language processor according to claim 2 wherein the execution interface enables the core language processor to configure each coprocessor under the operational control of the core language processor.

5. The core language processor according to claim 1 wherein each coprocessor includes at least one scalar register comprising a coprocessor status register indicating whether the coprocessor is busy or is available, and a scalar register that includes a coprocessor completion register indicating that the coprocessor has completed a task.

6. The core language processor according to claim 5 further including the ability to require each coprocessor to return task results to the core language processor upon completion of a task.

7. The core language processor according to claim 1 further having the capability to map its own registers and those of each coprocessor into a common address map.

8. The core language processor according to claim 1 further having the capability of stalling execution of instructions to a coprocessor until completion of a task in the coprocessor.

9. A network processing system including at least one core language processor for providing and controlling the programmability of the system, said core language processor controlling the operation of a plurality of coprocessors through a plurality of execution instructions including load/store, wait and branch, indirect coprocessor execute and direct coprocessor execute, said instructions being executable within said core language processor.

10. A network processing system according to claim 9 wherein each core language processor is connected to each of the coprocessors by two interfaces, an execution interface that enables the core language processor to initiate command execution on any of the coprocessors, and a separate data read and write interface.

11. A network processing system according to claim 10 wherein the execution interface enables the core language processor to configure each of the coprocessors under the operational control of the core language processor.

12. A network processing system according to claim 10 wherein the core language processor includes the ability to access status information of each coprocessor.

13. A network processing system according to claim 10 wherein each coprocessor includes at least one scalar register comprising a coprocessor status register, and a scalar register comprising a coprocessor completion register.

14. A network processing system according to claim 9 wherein each core language processor has the capability to map its own special purpose registers and those of each coprocessor into a common address map.

15. A network processing system according to claim 9 wherein each core language processor has the capability of stalling execution of instructions until completion of a task in a coprocessor.

16. The core language processor according to claim 15 further including the ability to require the coprocessor to return task results to the core language processor upon completion of a task.

17. A method for controlling the programmability of a network processor comprising:
(a) using at least one core language processor to control the operation of a plurality of coprocessors;
(b) controlling the operation by the use of a plurality of execution instructions including load/store, wait and branch, indirect coprocessor execute and direct coprocessor execute, and (c) executing all of said instructions within said core language processor.

18. The method according to claim 17 including the step of connecting the core language processor to each of the coprocessors by two interfaces, an execution interface that enables the core language processor to initiate command execution on any of the coprocessors, and a data read and write interface.

19. The method according to claim 18 wherein the execution interface configures the core language processor to each coprocessor under the operational control of the core language processor.

20. The method according to claim 15 further comprising using at least one scalar register comprising a coprocessor status register, and a scalar register including a coprocessor completion register.

21. The method according to claim 15 further including the step of mapping the registers of the core language processor and those of the coprocessors into a common address map.

22. The method according to claim 15 further including the step of stalling execution of instructions to a coprocessor until completion of a task in said coprocessor.
